(19) United States
(12) Patent Application Publication
(10) Pub. No.: US 2025/0349227 A1
(43) Pub. Date: Nov. 13, 2025

(54) METHOD AND SYSTEM FOR OPTIMIZING VOCABULARY SELECTION IN AUGMENTATIVE AND ALTERNATIVE COMMUNICATION (AAC) DEVICES

(71) Applicant: CENTRE FOR PERCEPTUAL AND INTERACTIVE INTELLIGENCE (CPII) LIMITED, Pak Shek Kok (HK)

(72) Inventor: Yuen Yan CHAN, Pak Shek Kok (HK)

(21) Appl. No.: 18/984,604

(22) Filed: Dec. 17, 2024

Related U.S. Application Data
(60) Provisional application No. 63/644,820, filed on May 9, 2024.

(51) Int. Cl. G09B 21/00; G06F 16/22; G06T 11/00

(52) U.S. Cl. CPC G09B 21/00; G06F 16/22; G06T 11/00

(57) ABSTRACT

Disclosed is a novel method and system for optimizing vocabulary selection in Augmentative and Alternative Communication (AAC) devices. The method involves receiving user input, encoding it into a sequence of indexes, augmenting and alternating the sequence of indexes into a plurality of communication symbols, generating optimal communication symbols for an optimized symbols selection, selecting the optimal communication symbols based on relevance to user input, and, displaying the optimized symbols for the sentence writing on a display interface of the AAC device.

### CROSS-REFERENCE TO RELATED APPLICATIONS

This application claims priority to U.S. Provisional Patent Application No. 63/644,820, filed on May 9, 2024, presently pending.

### FIELD OF THE INVENTION

The present invention relates to an augmentative and alternative communication (AAC) system for an AAC device and method thereof. More specifically, the AAC system incorporates a mathematical model for effective communication for verbally impaired individuals.

### BACKGROUND OF THE INVENTION

Rate distortion theory is a mathematical discipline that treats, from the information theory perspective, the trade-off between the information conveying rate and the information reconstruction fidelity at the output. Meanwhile, augmentative and alternative communication (AAC) employs symbol-based methods such as communication boards and picture-based communication applications to complement or substitute human verbal communication. Such an approach is often used by people with complex communication needs who are unable to conduct verbal conversations to cope with their everyday needs. However, their communicative needs cannot be fully met because of the operational noise and distortion of AAC devices. These include random physical and cognitive efforts required for symbol selection and systematic unavailability of desirable vocabulary.

Aided languages are alternative forms of language developed in children and adults who are unable to speak or sign due to severe motor impairments. Very often, graphic symbols such as pictures and line drawings are used with aided languages to substitute words. Aided language with graphic symbols is often used by children and adults whose speech and literacy skills have yet to develop or temporarily lost. An example is augmentative and alternative communication (AAC). Superordinate relations in linguistics refer to the hierarchical associations between words or concepts. In particular, superordinate terms (e.g., “animal”) represent categories or classes that contain one or more subordinate elements (e.g., “dog”, “cat”, etc.). Superordinate relations between words in a language form into a hyponymic structure for classifying the vocabulary of that language. Such a relation between language and classification has been leveraged by preschoolers and children using aided language when they communicate. Hyponymic structure between words are also utilised by WordNet as well.

Previous study shows that AAC symbol frequency exhibits Zipf's law characteristic as in many natural languages. Meanwhile, language forms found at AAC output show frequent missing or omitting of key communication elements. Such a phenomenon reflects communication inefficiency due to the source entropy rate exceeding the communication channel capacity.

To further enhance the AAC output, there are several studies involving rate distortion theory being applied in cognitive science to understand the nature of human cognition. For example, rate distortion theory has been introduced as a framework for understanding human perception, where perception is mathematically described as a cost minimization process subject to channel capacity constraints. Such an approach can explain salient observations in discrete categorization of stimuli and human visual working memory. Besides, rate distortion theory has been applied to formalize capacity-limited decision-making in biological and also artificial agents.

Related works in this direction include the rate distortion theory of learning targets as a sub-optimal policy has also been applied deliberately during reinforcement learning so as to reduce the bits of information to be obtained from the environment. In another work, rate distortion theory is employed to formalize the relationship between the information rate of human memory channels and the distortion in terms of the cost of memory errors. Their proposed model bridges between rate distortion theory and neural population codes; and can account for a range of phenomena in visual working memory.

In a recent study on mind, language, and communication, the rate distortion theory is applied to provide a computational-level model of errors and difficulties in human language production. It is shown that a wide range of human communication phenomena, such as word choice errors and disfluencies, can be explained within the rate distortion theoretic framework. Futrell's work is based on his proposed rate—distortion theory of control that regards an agent's action policy as a communication channel between sensory input and motor output, where the rate-distortion framework helped to find an encoding scheme which minimizes the distortion subject to a constraint on the information rate. Similar connection between informational constraints (i.e. how much information an agent may use during action selection) and the agent's perception-action loop has also been applied in artificial intelligence (AI) and robotics, such as hierarchical structuring of behavior in natural and artificial agents and bounded rational decision-making and hierarchical information processing in perception-action systems.

Thing language that empirically expresses the external refers to observable things in the world; and theoretical language that logically expresses the internal refers to unobservable abstract entities. There exists a unique semantical name-relation that maps an entity (such as a concept) to its nominatum (the Latin word for ‘name’). Two entities belong to the same class if both of them have the property of that class. Language is a system of signs and the rules for using them. In other words, a language consists of a vocabulary, which is a set of meaningful words, and a logical syntax, which is a set of rules governing elementary sentence formation from the words in the vocabulary. It has also been said that two consecutive elements in a sentence have a premise-consequence relationship. The composition of an expression (e.g., a sentence) from the entities (e.g., words) is governed by the way these elements are distributed in various classes. The former is governed by the syntactic formation rule, while the latter is governed by the semantic transformation rule, and this becomes the basis of the present invention.

A prior invention, United States patent publication no. 10085024B2, describes a system, like a video encoder, that retrieves quantization offsets for coefficients from a lookup table. The position of each coefficient within a block determines which offset is used. These offsets are then used, along with other factors, to calculate the final quantized values for the coefficients. Whilst said invention discloses a rate-distortion optimized optimized quantization lookup table for video coding, however, it may lack semantics consideration for the application in an AAC device.

European patent publication no. 3193239A1, describes methods and tools to aid communication for those who struggle with speaking or using traditional methods. In one example, the system receives an input, checks if it is intentional (meaningful user action), and then generates a response based on that input. However, said invention only allows the expression of a binary “intention” or “no intention” signal by the user and considering that a vocabulary for an AAC device may have multiple symbols, wherein each carrying a unique meaning, such meaning, the input provided by the user may not be accurate.

China patent publication no. 116343996A describes a supplementary rehabilitation system and method for speech disorders. The system consists of three main modules: a data acquisition module, a data transmission module, and a data processing module. The data acquisition module captures the daily voice data of individuals with speech impairments using an audio recorder. The data transmission module then sends and archives this collected voice data to a cloud server. Subsequently, the data processing module retrieves the daily voice data via client devices, applies an embedded artificial intelligence voice processing model to analyse the data, and produces both a rehabilitation training regimen and a training report. Said invention employs speech processing approach to enhance the rehabilitation of communication disabilities with no disclosure on the application of algebraic structure that will enhance symbols selection for an effective communication.

China patent publication no. 111261146A introduces a method, device, and storage medium for speech recognition and model training. The method involves acquiring a first loss function for a voice separation enhancement model and a second loss function for a voice recognition model. Backpropagation is then performed based on the second loss function to train an intermediate model between the speech separation enhancement and recognition models, resulting in a robust representation model. Subsequently, the first and second loss functions are fused to create a target loss function. Joint training on the voice separation enhancement, robust representation, and voice recognition models is conducted using the target loss function, with training concluding upon meeting a preset convergence condition. This approach enhances voice recognition accuracy. Whilst said invention disclosed speech recognition and language model training, however said invention lacks semantic structure of symbol and rate-distortion function for effective symbol selection and effective communication using the AAC device.

In view of the above, an atypical use of communication symbols, such as having multiple AAC symbols with overlapping meanings simultaneously, will cause anomalies in the rate-distortion function. Therefore, there is a need for a solution to reduce the level of distortion while the rate required to transmit a message remains unchanged in an AAC device for non-verbal individuals.

### SUMMARY OF THE INVENTION

It is an objective of the present invention to provide a mathematical model for an augmentative and alternative communication (AAC) device with a rate-distortion function to obtain a spatial arrangement of symbols for effective communication using the device.

It is also an objective of the present invention to apply the mathematical model for the augmentative and alternative communication (AAC) device to rank the symbols by their frequency of occurrence based on the user's intended message sequence for effective communication.

Another objective of the present invention to provide an augmentative and alternative communication device is to optimise the spatial arrangement of symbols with a low rate-distortion on a board or across the pages of display of the device so that they are maximally usable.

Generally, the present invention relates to a method for optimizing symbols selection for a sentence writing in an Augmentative and Alternative Communication (AAC) device comprising: receiving at least one user input; encoding the user input as a sequence of indexes; augmenting and alternating the sequence of indexes into a plurality of communication symbols; generating optimal communication symbols for an optimized symbols selection; selecting the optimal communication symbols based on relevance to user input; and, displaying the optimized symbols for the sentence writing on a display interface of the AAC device.

The present invention also provides a system for optimizing symbols selection for a sentence writing in an Augmentative and Alternative Communication (AAC) device comprising: a database; a processor in data communication with the database having instructions thereon that, when executed by the processor, cause the processor to: receive at least one user input; encode the user input as a sequence of indexes; augment and alternate the sequence of indexes into a plurality of communication symbols; generate optimal communication symbols for an optimized symbols selection; select the optimal communication symbols based on relevance to user input; and, display the optimized symbols for the sentence writing on a display interface of the AAC device.

### BRIEF DESCRIPTION OF DRAWINGS

The features of the invention will be more readily understood and appreciated from the following detailed description when read in conjunction with the accompanying drawings of the preferred embodiment of the present invention in which:

FIG. 1 illustrates an embodiment of the present invention to convey the user's message=X₁, X₂, . . . via augmentative and alternative communication (AAC) device and outputs a sequence of AAC symbols=\hat{X}₁, \hat{X}₂, . . . to the receiver.

FIG. 2 illustrates a conceptual universe.

FIG. 3 illustrates a superordinate relations and semantic structure of a set of concepts.

FIG. 4 illustrates symbols and their hyponymic structure κ:S→S′ consists of superordinate relations \hat{v}:C→C′.

FIG. 5 illustrates a semiotic morphism between concepts and graphic symbols in aided language.

FIG. 6 illustrates a graphic symbol sequence in aided language produced by recursive composition of graphic symbols wherein superscripts inside the square bracket indicate the current state of composition.

FIG. 7 illustrates a basic coding scheme for an AAC Device.

FIG. 8 illustrates a user's intended tokens and the corresponding symbols output by the AAC device wherein the stop words (“to” and “an”) are neglected.

FIG. 9 illustrates a graph of distortion vs. the size for SAHK AAC vocabulary.

FIG. 10 illustrates a graph of distortion vs. the size for Hong Chi AAC vocabulary.

FIG. 11 illustrates a graph of distortion vs. the size for Universal Core vocabulary.

FIG. 12 illustrates a graph of distortion vs. the size for SAHK AAC vocabulary.

FIG. 13 illustrates a graph of rate vs. vocabulary size for the Hong Chi AAC symbols.

FIG. 14 illustrates a graph of rate vs. vocabulary size for the Universal Core AAC symbols.

FIG. 15 illustrates a graph of rate-distortion function for popular Cantonese AAC vocabularies, and the Universal Core evaluated against N=264,913 source sentences.

FIG. 16 illustrates a graph of the distortion-rate function with single-letter distortion measure and K-single letter distortion measure for the SAHK vocabularies evaluated against N=264,913 source sentences.

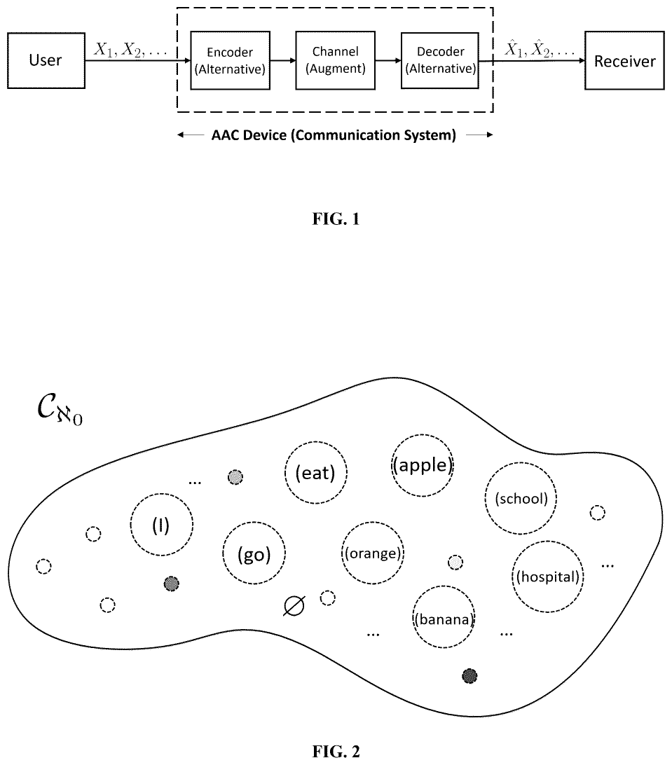

### DETAILED DESCRIPTION OF THE INVENTION

For the purposes of promoting and understanding the principles of the invention, reference will now be made to the embodiments illustrated in the drawings and described in the following written specification. It is understood that the present invention includes any alterations and modifications to the illustrated embodiments and includes further applications of the principles of the invention as would normally occur to one skilled in the art to which the invention pertains.

Generally, the present invention relates to a method for optimizing symbols selection for a sentence writing in an Augmentative and Alternative Communication (AAC) device comprising: receiving at least one user input; encoding the user input as a sequence of indexes; augmenting and alternating the sequence of indexes into a plurality of communication symbols; generating optimal communication symbols for an optimized symbols selection; selecting the optimal communication symbols based on relevance to user input; and, displaying the optimized symbols for the sentence writing on a display interface of the AAC device.

In one of the embodiments, the method further comprises accessing a database that stores a plurality of data; and capturing user interactions and the evaluation data through a feedback mechanism to the database for an adaptive learning.

In one of the embodiments, the step of encoding the user input as the sequence of indexes further comprises identifying a plurality of concepts based on the at least one user input, wherein each concept is represented by an index.

In one of the embodiments, the step of augmenting and alternating the sequence of indexes into the plurality of communication symbols further comprising of applying a first algebraic model to assign a communication symbol to each identified concept or a null symbol for concepts that lack a direct symbolic representation.

In one of the embodiments, the step of augmententing the sequence of indexes in the plurality of communication symbols further comprising of maintaining a signal-to noise ratio in the sequence of indexes via a channel capacity (C).

In one of the embodiments, the method further comprising: applying a second algebraic model to generate a sequence of indexes with semantic structure.

In one of the embodiments, the method further comprising: defining superordinate relations amongst the communication symbols via an injective mapping; and, assigning a single-class symbol to each concept to obtain the sequence of indexes.

In one of the embodiments, the method further comprising: establishing a distortion metric by scoring each communication symbol and establishing a distortion threshold level; calculating mutual information between the user input and decoded communication symbols; determining a minimum information rate based on the threshold distortion level; and selecting the optimal communication symbols in accordance with the distortion threshold level, wherein symbols meeting or exceeding the threshold level are prioritized for display in the AAC device; and, measuring a single-letter distortion (d) as:

$$d ( {x}_{k} , {\hat{x}}_{k} ) = \{ \begin{matrix}0 if f ( {x}_{k} ) \neq 0 \\ 1 if f ( {x}_{k} ) = 0\end{matrix}$$

where x is a source sequence, \hat{x} is a reproduction sequence, k is an index.

In one of the embodiments, the method further comprising: establishing a distortion metric by scoring each communication symbol and establishing a distortion threshold level; calculating mutual information between the user input and alternated communication symbols; determining a minimum information rate based on the distortion threshold level; selecting the optimal communication symbols in accordance with the distortion threshold level, wherein symbols meeting or exceeding the threshold level are prioritized for display in the AAC device; and, measuring a single-letter distortion with the semantic structure (dₖ) as:

$${d}_{k} ( {x}_{k} , {\hat{x}}_{k} ) \leq d ( {x}_{k} , {\hat{x}}_{k} )$$

where xₖ and [symbol] are, respectively, the k-th symbol in the source and the reproduction sequence.

In one of the embodiments, the method further comprising: measuring a K-single-letter distortion between xₖ and \hat{X}ₖ, as:

$$d ( {x}_{k} , {\hat{x}}_{k} ) = \{ \begin{matrix}0 & if f ( {x}_{k} ) \neq 0 \\ {d}_{k} & if f ( {x}_{k} ) = 0 and κ ( k ) ∈ {I}^{′} \\ 1 & otherwise\end{matrix} ,$$

$$where ,$$

$${d}_{k} = \frac{( {\sum }_{κ ( j ) = κ ( k )} {n}_{j} ) - {n}_{k}}{{\sum }_{κ ( j ) = κ ( k )} {n}_{j}}$$

where, the symbol \hat{x} is replaced by its class symbol [symbol] , denoting the class for the symbol; and, representing a class for each symbol quantitatively as:

$$1 - {d}_{k} = \frac{{n}_{k}}{{\sum }_{κ ( j ) = κ ( k )} {n}_{j}}$$

In one of the embodiments, the step of measuring the single letter distortion further comprising: minimizing distortion between the user input and the reproduction sequence.

In one of the embodiments, the step of minimizing distortion between the user input and the reproduction sequence further comprising: determining a channel (Q*) as:

$$Q *= {arg min}_{Q : R ( D ) \leq C} R ( D )$$

$$where ,$$

$$D = {\sum }_{x , \hat{x}} {p}_{x , {\hat{x}}^{( x , \hat{x} ) d ( x \hat{x} )}}$$

$$and ,$$

$${\sum }_{x , \hat{x}} p ( x ) p ( \hat{x} \vert x ) d ( x , \hat{x} ) \leq D$$

where D is the average distortion measure d(x, \hat{X}) weighted by the joint probability distribution Pₓₓ(x, \hat{x}), and, p(x) is known data obtained from the database.

In one of the embodiments, the method further comprising: achieving minimum information rate, R, (D) as:

$${R}_{1} ( D ) = {min}_{p ( x \vert \hat{x} ) : {\sum }_{x , \hat{x}} p ( x ) p ( \hat{x} \vert x ) d ( x , \hat{x} ) \leq D} I ( X ; \hat{X} )$$

The present invention also teaches a system for optimizing symbols selection for sentence writing in an Augmentative and Alternative Communication (AAC) device comprising: a database; a processor in data communication with the database having instructions thereon that, when executed by the processor, cause the processor to: receive at least one user input; encode the user input as a sequence of indexes; augment and alternate the sequence of indexes into a plurality of communication symbols; generate optimal communication symbols for an optimized symbols selection; select the optimal communication symbols based on relevance to user input; and, display the optimized symbols for the sentence writing on a display interface of the AAC device.

In one of the embodiments, the database includes, but is not limited to, a cloud database.

In one of the embodiments, the database stores a plurality of data including but not limited to user interactions data, performance data, at least one vocabulary library, and user model data.

In one of the embodiments, the user model data includes user preferences and user performance metrics.

In one of the embodiments, the vocabulary library is customizable, allowing user-specific symbols are added in the vocabulary library.

In one of the embodiments, the system is configurable for implementation across various AAC devices.

In one of the embodiments, the AAC system is further configured to minimize rate-distortion for symbol selection within an AAC library. This is made possible due to a mathematical model constructed and implemented throughout the AAC system based on the theory that the operational definition equates to an information definition of an AAC device.

In one embodiment, examples of AAC devices include but not limited to communication boards, picture-based systems, speech-generating devices and mobile applications on tablets and smartphones. In addition, augmentative input methods such as eye-gaze and head trackers, special switches, keyboards, and pointing devices are also available for individuals with physical disabilities and limited mobility. As a system that enables non-verbal individuals to convey information, AAC seamlessly aligns with a previously-studied mathematical model that describes the transmission of information from a source (e.g., a non-verbal user) to a destination (e.g., the outside world).

### Signs, Symbols and Language

In order to further understand the invention, it is important to understand the theory behind it. More particularly, semiotics is the study of signs and views language as a system of signs that expresses ideas. A sign is interpreted as its referred conceptual entity through the process of semiosis. In particular, symbols is a type of sign in which the relationship between the representation and the object can be attributed to certain social conventions. In this way, internal feelings and thoughts in one's mind can be represented by symbols and conveyed in the real world through communication. For people with communication disabilities, the representation of meanings or mental concepts by graphic symbols as an alternative to verbal tokens, such as written or spoken words, is central to their daily needs and social interactions. A sign is further defined as a combination of a sound-image (e.g. a spoken or written word) (the signifier) together with a concept (the signified). It is further distinguished between language (langue) and speech (parole). Langue refers to the internal linguistic structure that a person develops within his or her cognitive system, while parole is the external representation of langue.

### Augmentative and Alternative Communication

Verbal communication is a complex task involving both cognition and behavior. A speaker needs to transform the intended communication content into a series of motor actions in vocal organs in real-time so as to produce physical utterances. The uttering of sounds of the intended words is an inborn instinct in typically developed human individuals. However, such a task can be challenging for children and adults having various communication disabilities. AAC refers to methods or systems for supporting or replacing verbal communication, such as speaking or writing, for individuals with communication difficulties. Examples of AAC devices include communication boards, picture-based systems, speech-generating devices and mobile applications on tablets and smartphones. In addition, augmentative input methods such as eye-gaze and head trackers, special switches, keyboards, and pointing devices are also available for individuals with physical disabilities and limited mobility.

As a system that enables non-verbal individuals to convey information, AAC seamlessly aligns with the mathematical model that describes the transmission of information from a source (e.g., a non-verbal user) to a destination (e.g., the outside world). Specifically:
Augmentative implies the provision of assistive input methods to improve signal-to-noise ratio and therefore increase channel capacity between the user and the outside world.
Alternative means the use of alternative modalities, such as picture-based communication symbols to replace verbal utterances.
Communication suggests that AAC is essentially a communication method for a non-verbal user to send intended messages to a receiver as a reduced symbols set.

### Vocabulary Selection in AAC Systems

In AAC practice, vocabulary selection refers to the task of choosing which symbols from

thousands of candidates should be included in an individual user's AAC system. Vocabulary selection remains a complex process for AAC professionals because of the different vocabulary needs across different contexts and users. A related problem is to optimise the spatial arrangement of these symbols on a board or across the pages of display of the AAC device so that they are maximally usable. A popular approach for AAC vocabulary selection is based on the frequency of symbol use. For example, informed by applied linguistics research on core vocabulary, a list of 200 to 400 frequently used words for AAC users has been compiled and arranged in order of descending frequency to equip them with a survival kit of core words. However, it remains challenging to achieve an optimal balance between the size of the vocabulary set to cover as many thoughts and ideas as possible and the user's effort and cognitive load to navigate and retrieve the corresponding symbols.

The following paragraphs describe the mathematical model in depth:

The mathematical model is constructed based on a conceptual universe, concepts, and small classes of concepts, and this is illustrated in FIG. 2. More specifically, in a conceptual universe, CN [symbol] 0 is an infinite set of well-ordered concepts. [symbol] contains a finite set of concepts C={c₀, c₁, . . . , c_{N}} where care distinct elements indexed by i∈l={0, 1, . . . , N}. In particular, c₀ is the null concept and is denoted by Ø; and a finite set of small classes C′={c′₀, c′₁, . . . , c′_{K}} where c′j indexed by j∈J={0, 1, . . . , K} are small classes of concepts. In particular, c′₀ is the null class and is denoted by Ø. It is required that the non-null elements in C and C′ do not overlap and the final equation will be C′∩C=Ø.

In one embodiment, the AAC system further comprising of superordinate relations amongst communication symbols. The aim of obtaining the equations for this is to provide a priori semantic structure of AAC vocabularies with the substitution of a class of symbols with a single-class symbol.

In view of the above, the superordinate relations are further defined via an injective mapping u: C′→C such that:
for each member c′ of C′, there is at least one member c of C for which u(c′)=c; and;
there exists a surjective mapping v: C→C′ so that v·f=1c′.

It follows that any v defined above is a retraction for u where C′ is a retract of C via v and u.

Furthermore, there exists an idempotent endomap, ε where C [symbol] C and u○v=ε such that the pair (u, v) is a splitting for ε.

There exists a particular mapping \hat{v} that sorts c∈C into c′∈C′ according to whether c has the semantic property of c′. Specifically, \hat{v} is a particular N to K mapping that maps some i-th element of C to some j-th element of C′ according to their intrinsic meanings.

### Superordinate Relations

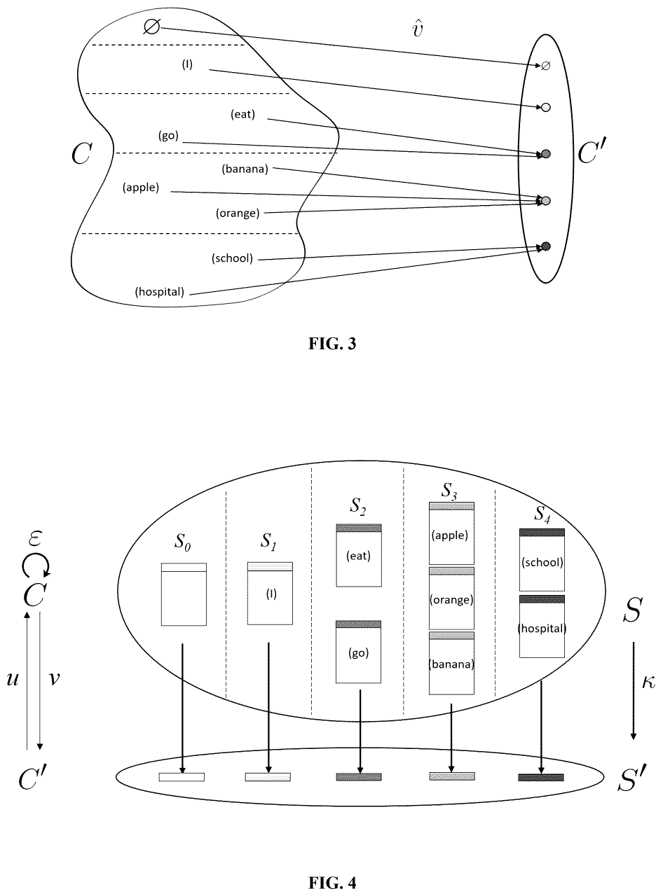

The set of superordinate relations, V is a set of arrows {vᵢⱼ∈V|cᵢ→c′ⱼ∈\hat{v}, i∈I, j∈J} that specifies the relation from each of the concepts c∈C to some small concept classes c′∈C′. The semantic structure of C can then be specified by C′ together with \hat{v} (FIG. 3). In other words, the hyponymic structure of C can be described uniquely by (J, \hat{v}) and is invariant across all language system operations.

The symbols, hyponymic structure and symbol classes are further defined in the following paragraphs.

### Communication Symbols

A communication symbol is an element sᵢ∈S={s₀, s₁, . . . , s_{N}}, where each element in s∈S is referencing a concept in c∈C having the same index i E I.

### Hyponymic Structure of Symbols

The hyponymic structure K holds in S in a way that S is sorted into (Sₖ)_{k∈J} by J through the mapping g. I.e., there exists a family of symbols (Sₖ)_{k∈J} such that Sₖ={sᵢ∈S|ĝ(i)=j, i∈I, j∈J}.

### Symbol Classes

A symbol class is an element s′ⱼ∈S′={s′₀, s′₁, . . . , s′_{κ}} where each element in S′ is a class memberships of symbols and referencing a small concept class in C′ having the same index j∈J. κ defines the subordinate-to-superordinate relations of all symbols in S and symbol classes in S′. Paras 46 and 47 are further illustrated with the help of an example where S={a₀, . . . , a₉} is a set of symbols referencing individual concepts {null, I, eat, go, apple, orange, banana, school, hospital} and S′={s′₀, . . . ,s′₅} referencing individual classes of concepts {null, people, activities, fruit, places} (FIG. 4). Without loss of generality, it is assumed that the symbols in S are the graphic symbols used by aided communicators.

Therefore, the algebraic description provided in an aided language system LN having N graphic symbols and K superordinate classes. The sentence composition and language rules begin and are followed by the definition of an aided language based on the symbols and their operation rules.

Two-token Sentences in a Sentence Composition

In another embodiment, for a sentence composition in the AAC system, for example, in two-token sentences, let S*=(S, ⊙, e) be the free monoid on the set of graphic symbols S where:
⊙ is a binary associative operation which is the concatenative composition; and,
e is an identity element, which is the null sign. And e=s₀ and it has a class membership s′.

A two-token sentence sᵢⱼ is the one resulted from the binary operation ⊙∈S* between two symbols sᵢ, sⱼ∈S such that:

$${s}_{ij} = {s}_{i} ⊙ {s}_{j} \qquad ( 1 )$$

Given a finite set of symbols, an infinite set of sentences, which are symbol sequences, can be obtained from the recursive concatenative composition of individual symbols.

### Language Rules in a Sentence Composition

As for the language rules, let S_{X} and S_{Y} be two instances of S*. Let S_{xy}=Sₓ⊙s_{y} for sₓ∈S_{X} and s_{y}∈S_{Y} be a two-token sentence, such that sₓ is the subject and s_{y} is the predicate held by the (relationship. Given the hyponymic structure k of S and following Carnap's logical syntax of languages, there are two rules that together describe the syntactical relation from SX to S_{Y}:
i) The transformation rule Σ: S_{X}→S′_{Y} that describes the logical relation between the subject and the class of the predicate (or the predicate class). For example, s′_{y} can be logically derived from s_{y}, and it can compose an analytic sentence s′_{xy}=(sₓ⊙s′_{y}) from s_{xy}; such as composing “eat” “fruit” from “eat” “(an) apple”.
ii) The formation rule ϕ: S′_{y}→S_{Y} that describes the validity of the syntax of sentences. For example, given that s′_{xy}(e.g. “eat fruit”) is syntactically valid, ϕ describes the syntactic validity of the replacement of s_{y} (e.g. “fruit”) in s′_{xy} by s_{y} (e.g. “(an) apple” or “(an) orange”).

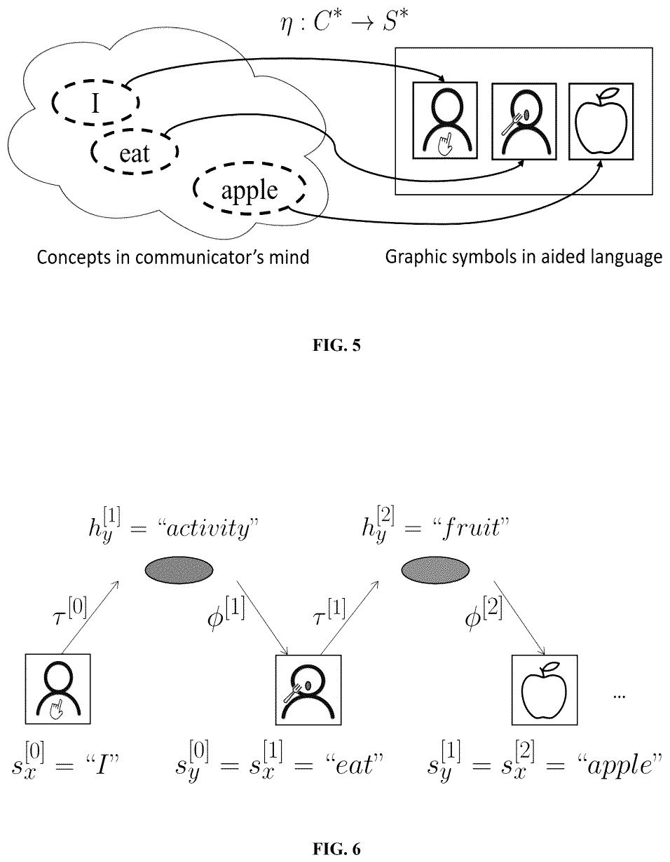

For any aided language system, including the AAC device, L_{N} is a finite system of graphic symbols S and of rules (τ, ϕ) for two-token sentence composition. Let C* be a monoid defined similarly to S *. It is important to notice that there exists a semiotic morphism n between concepts C and graphic symbols S, preserving the hyponymic structure κ (FIG. 5). In this way, communicators with limited motor and/or mental ability to utter or write words in natural languages can express themselves using the graphic symbols in the AAC device.

In addition to the construction of the mathematical model, symbol sequences production for the AAC device is developed using the following mathematical equations below:

Given a set of non-null graphic symbols {s₁, . . . , s_{N}}, a set of N×N possible two-symbol sentences {S_{xy}: S_{xy}=(sₓ¦s_{y})|sₓ∈S_{X}, s_{y}└S_{Y}} can be formed by the concatenative composition of subject symbol sₓ and predicate symbol s_{y}. Moreover, an infinite number of symbol sequences with length>2 can be formed by recursively applying the transformative and formative rules to the symbols and symbol classes (FIG. 6). In particular, the formation rules ϕ[t] . . . for all t∈ [symbol] + are subordinate relations defined in κ; while κ is invariant across sentence composition and sequence production.

In one embodiment, the mathematical model is implemented into the AAC device, wherein when an input is inserted by a user using the AAC device to output the alphabets, the following mathematical considerations are implemented:

Let there be an independent and identically distributed (i.i.d.) information source with a generic random variable X and probability distribution p(x) (Note: such a memoryless source is a common assumption in the bag-of-words model in natural language processing). The support of X is equal to the source alphabet X where |X|<∞. Let the source sequence be:

$$x = ( {x}_{1} , {x}_{2} , … . , {x}_{n} ) \qquad ( 2 )$$

and the reproduction sequence at output \hat{X} be:

$$\hat{x} = ( {\hat{x}}_{1} , {\hat{x}}_{2} , … , {\hat{x}}_{n} ) \qquad ( 3 )$$

where \hat{X} i.i.d.˜p(\hat{x}) and \hat{x}∈\hat{X}ⁿ for the reproduction alphabets \hat{X}ⁿ, and |X|<∞.

The mathematical model includes a rate-distortion code wherein an (n, M) with an encoding function:

$$f : {X}^{n} \to \{ 1 , 2 , … , M \} \qquad ( 4 )$$

and a decoding function:

$$g : \{ 1 , 2 , … … , M \} \to {\hat{X}}^{n} \qquad ( 5 )$$

where {1, 2, . . . , M}=I is the index set. The set of n-tuples gₙ(1), gₙ(2), . . . , gₙ(M) in the reproduction sequence, denoted by \hat{X}ⁿ(1), . . . , \hat{X}ⁿ(M)∈\hat{X}ⁿ are the codewords that make up the codebook, where f⁻¹n(1), . . . , f⁻¹n(M) are the corresponding assignment regions.

In furtherance to the above, there is a code to measure distortion. For example, for source alphabet X and reproduction alphabet \hat{X}, a distortion measured is defined as a mapping

$$d : X \times \hat{X} \to {+}^{} \qquad ( 6 )$$

where [symbol] + is a set of non-negative real numbers.

The distortion, d(x, \hat{x}) is a measure of the cost of using the symbol “\hat{x}” to represent the symbol x. While the distortion between the source sequence X and reproduction sequence \hat{X} is given by:

$$d ( x , \hat{x} ) = \frac{1}{n} {\sum }_{k = 1}^{n} d ( {x}_{k} , {\hat{x}}_{k} ) \qquad ( 7 )$$

For a source X producing original sequence x₁, x₂, . . . ∈Xₙ that were output as \hat{X}₁, \hat{X}₂, . . . ∈\hat{X}ₙ at \hat{X}, the distortion, D is defined as:

$$D = E [ d ( x , \hat{x} ) ] \qquad ( 8 )$$

In order to obtain the information rate-distortion function, the following mathematical considerations are disclosed. Given D≥0, the information rate-distortion function of source X and output \hat{X} is defined by:

$${R}_{1} ( D ) = {min}_{\hat{x} : E [ d ( x , \hat{x} ) ] \leq D} I ( X ; \hat{X} ) \qquad ( 9 )$$

for mutual information/between X and \hat{X}. Therefore, RI (D) is the minimum value of I (X; \hat{X}) for a specified distortion level D. Furthermore, given the channel capacity C,

$${R}_{I} ( D ) < C \qquad ( 10 )$$

that ensures the possibility of achieving distortion D.

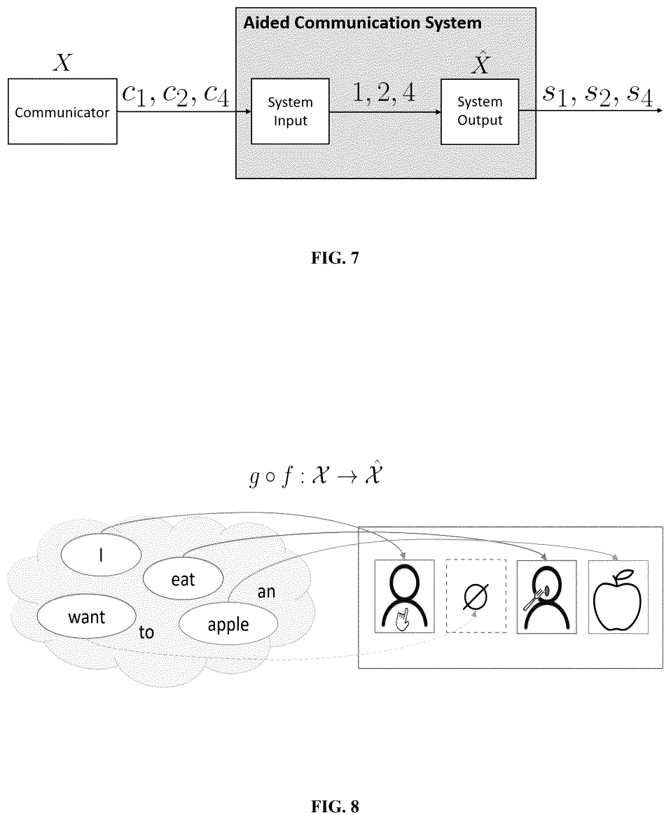

In one embodiment, the AAC device acts as a communication system Q between the user and the outside world (FIG. 7). It takes input x from user X, and outputs \hat{x} on the device's output interface \hat{X}. The user can interact with the AAC device via a variety of input methods, such as screen touching and eye-tracking. These methods encode the user's intended words x∈X into a sequence of indexes f(x)∈I, which can then be uniquely decoded as an AAC symbol which is a codeword \hat{x}∈\hat{X} by some method g such as showing a certain picture card on the digital screen, where g·f(x)=\hat{X}. As a communication system, the AAC device is described by a probabilistic mapping Q(\hat{X}|X). Besides, both the user input and display output spaces are discrete. The capacity limit C depends on the total number of distinct AAC symbols available in the device. It is an upper limit on the amount of information the device can output for the user, which equals the mutual information I (X; \hat{X}) wherein, I (X; \hat{X}) equals to the AAC rate-distortion function R(D) and therefore depends on d(x, \hat{x}).

In another embodiment, the AAC system further comprising of a first AAC coding scheme which is also a basic coding scheme. In this example, AAC symbols are set to be an (n, M) code having a codebook C. The M distinct codewords are denoted by {\hat{x}(1), \hat{x}(2), . . . , \hat{x}(M)}, each representing some semantic meaning. The codebook C is revealed to the user, e.g., through communication skills lessons. In addition, a null codeword \hat{x}(0)=Ø having an index 0 is introduced. Given a source sequence x=(x₁, x₂, . . . , xₙ), the AAC coding scheme is described below:
1) For each x in x, the AAC encoder encodes x into an index K where.
   K=i when there exists an AAC symbol \hat{x}(i)=g·βf(x)∈\hat{X} such that \hat{x}(i) and x are jointly typical.
   Otherwise, let K=0.
   The index K is returned to the AAC decoder.
2) The decoder outputs \hat{x}(K)=g·f(x) as the AAC symbol conveying x. Moreover, an intended word with no jointly typical AAC symbol will be encoded into the null symbol \hat{x}(0).

In another embodiment, the AAC system further comprising of a second AAC coding scheme, which is a modified version of the first AAC coding and said coding scheme is further comprising of a semantic structure. In addition to the first AAC coding scheme or the basic AAC coding scheme, the second AAC coding has been modified to introduce class symbols and the a priori semantic structure into the coding procedure. The modified scheme is further described below:
1) For each x in x, the AAC encoder encodes x into an index K where
   K=i when there exists an AAC symbol \hat{X}(i)=g·f(x)∈\hat{X}such that \hat{x}(i) and x are jointly typical.
   Otherwise, let K=0.
   The index K is returned to the AAC decoder.
2) If K≠0, the decoder outputs \hat{X}(K)=g·f(x) as the AAC symbol conveying x.
3) Else if K=0 and K (i)=i′∈I_{M′}, the decoder outputs the class symbol \hat{X}′(κ(K)) to substitute \hat{X} and convey x.

Since K is surjective, therefore, IM′≤IM. By introducing κ, the original message can be encoded using a smaller set of AAC symbols by substituting them with their class symbols.

In one embodiment, both coding schemes (the first and second AAC coding schemes) are tested with and without semantic structure in order to achieve a single-letter distortion. For example, the AAC device attempts to output reproduction sequence \hat{X} that attempts best to convey the meaning in the original source sequence x. The single letter distortion measures specified below to reflect the distortion between a letter xx in the source alphabet and \hat{X}ₖ in the reproductive alphabet.

In furtherance to the above embodiment, the source sequence x and reproduction sequence \hat{X} of an (n,M) code, the single-letter distortion measures between xₖ and \hat{X}ₖ for 1≤k≤n is given by:

$$d ( {x}_{k} , {\hat{x}}_{k} ) = \{ \begin{matrix}0 & if f ( {x}_{k} ) \neq 0 \\ 1 & if f ( {x}_{k} ) = 0\end{matrix} \qquad ( 11 )$$

Let K be a prior semantic structure of a vocabulary. Let nₖ≥0 for 1≤k≤n be the frequency of occurrence of symbol xₖ in the source sequence. For source sequence x and reproduction sequence \hat{X} of an (n,M) code, the K-single-letter distortion measures between xₖ and \hat{X}ₖ is given by

$$d ( {x}_{k} , {\hat{x}}_{k} ) = \{ \begin{matrix}0 & if f ( {x}_{k} ) \neq 0 \\ {d}_{k} & if f ( {x}_{k} ) = 0 and κ ( k ) ∈ {I}^{′} \\ 1 & otherwise\end{matrix} , \qquad ( 12 )$$

$$where ,$$

$${d}_{k} = \frac{( {Σ}_{κ ( j ) = κ ( k )} {n}_{j} ) - {n}_{k}}{{Σ}_{κ ( j ) = κ ( k )} {n}_{j}} \qquad ( 13 )$$

measures the distortion when a symbol \hat{X} is replaced by its class symbol \hat{X}′, such as replacing “an apple” by “fruits”. In particular, the equation:

$$1 - {d}_{k} = \frac{{n}_{k}}{{Σ}_{κ ( j ) = κ ( k )} {n}_{j}} \qquad ( 14 )$$

quantifies how representative the class symbol (e.g., “fruits”) to the original symbol (e.g., “an apple”) is in terms of the fraction of occurrences of that particular symbol out of all symbols under the same class.

In this present invention, the term “Lemma 1” refers to single letter distortion with semantic structure and the same term may be used in the subsequent paragraphs. In this case specifically, for a set of codes with a semantic structure κ, the single letter distortion measures:

$${d}_{k} ( {x}_{k ,} {\hat{x}}_{k} ) \leq d ( {x}_{k ,} {\hat{x}}_{k} ) , \qquad ( 15 )$$

where xₖ and \hat{X}ₖ are, respectively, the k-th symbol in the source and reproduction sequence.

Provided herewith is evidence on the equation that leads to the reproduction sequence. Let f(x)≠0, according to Equations (11) and (12); d(xₖ, \hat{X}ₖ)=dₖ(xₖ, \hat{X}ₖ)=0. Let f(x)=0 and κ(k)/∈I′, and d(xₖ, \hat{X}ₖ)=dₖ(xₖ, \hat{X}ₖ)=1. Lastly let f(xk)=0 and κ(k)∈I′, and d(xₖ, \hat{X}ₖ)=0 and dₖ(xₖ, \hat{X}ₖ)=dₖ while dₖ≤1 for nₖ≥0 and therefore dₖ(xₖ, \hat{X}ₖ)<d(xₖ, \hat{X}ₖ).

Given the single-letter distortion measure d(xₖ, \hat{X}ₖ), as well as the k-single-letter distortion measure dx (xₖ, \hat{X}ₖ), the distortion measure d(xₖ, \hat{X}ₖ) can then be obtained from Equation (8). It indicates the expected number of words in the source sequence x that do not have any jointly typical symbols (or the substituting class symbols) on the AAC codebook C. Furthermore, in defining R(D) for said AAC device, the minimization of E[d(x, \hat{X})] is required and the complete equation is shown below:

$$E [ d ( x , \hat{X} ) ] \leq D \qquad ( 16 )$$

The basic AAC encoding and distortion are further investigated and the scenarios are further discussed below.

FIG. 8 illustrates one embodiment wherein the user's intended tokens and the corresponding symbols output by the AAC device and the stop words (“to” and “an”) are neglected. Let X and \hat{X} be the finite sets of word tokens and the AAC symbols that make up the AAC vocabulary, respectively. Consider a user's intended sentence “I want to eat an apple.”, which can be tokenized to x=(x₁, x₂, x₃, x₄)={, want, eat, apple} using popular natural language processing and pre-processing methods including stop-words removal. Suppose the target AAC vocabulary contains symbols that are jointly typical with the tokens I, eat, apple except want, the encoding scheme as described in paragraphs 37 to 39 that will encode x into the reproduced sequence (\hat{x}₁, \hat{x}₂, \hat{x}₃, \hat{x}₄). Here, the symbols having non-zero indexes are those within the AAC vocabulary that are jointly typical representations of the f. However, there is no such symbol available for the token want, so it is encoded to K=f(x2)=0 where the corresponding symbol is \hat{X}(0)=g·f(0)=Ø. The resulting reproduced sequence is composed of three non-null symbols, which correspond to the semantic concepts “I”, “eat”, and “apple”.

Furthermore, by Equations (6) and (10), the distortion measure is given by d(x, \hat{x})=¼ (0+1+0+0)=0.25.

In one example, the information theoretic design problem for AAC is identified in order to find the channel Q* that minimized expected distortion D=E[d(x, \hat{X})] subject to the constraint that R(D)<C, i.e.,

$$Q *= {arg min}_{Q : R ( D ) \leq C} R ( D ) \qquad ( 17 )$$

$$where$$

$$D = {\sum }_{x , \hat{x}} {p}_{X , \hat{X}}^{( x , \hat{x} ) d ( x , \hat{x} )} \qquad ( 18 )$$

is the average distortion measure d(x, \hat{X}) weighted by the joint probability distribution p_{x,x}(x, \hat{X}). Since p(x) can be known (e.g., from conversation logs or corpus), the minimisation is taken over all conditional distribution p(\hat{x}|x) such that:

$${\sum }_{x , \hat{x}} p ( x ) p ( \hat{x} \vert x ) d ( x , \hat{x} ) \leq D . \qquad ( 19 )$$

In one embodiment, the rate-distortion function for the AAC system having output \hat{X} and user X with i.i.d. distribution, p(x) and bounded distortion function d(x, \hat{X}) equals the associated rate-distortion function. Where the minimum achievable information rate R/(D) at distortion D is:

$${R}_{I} ( D ) = {min}_{p ( x \vert \hat{x} ) : {Σ}_{x , \hat{x}} p ( x ) p ( \hat{x} \vert x ) d ( x , \hat{x} ) \leq D} I ( X ; \hat{X} ) \qquad ( 20 )$$

wherein, R(D) equals R(D). Considering that the AAC rate-distortion function, R(D) in the AAC system has been defined, the algorithms found in the AAC system of the present invention are curated based on the following findings, wherein the minimum coding rate for achieving a distortion D≥0 in an AAC device equals the rate-distortion R(D). In other words, R(D) of an AAC device specifies the minimum user input rate and, therefore, the minimum device capacity C necessary for a specified average distortion level D.

In view of the above, experiments have been conducted and tested using real-life data to test the efficiency of the present invention. All equations, algorithms and information necessary for the design of the present invention are further discussed below.

### Example 1

Described as follows are the methods (including the information and calculations/algorithms involved in the development of the present invention, more specifically on the mathematical model part of the AAC system in the AAC device and the experimental results using real-life data for real-life applications for verbally impaired individuals.

### Methodology

### Data

The source data comes from the CHILDES Cantonese Lee Wong Leung corpus, which is a dataset contains longitudinal data collected from a number of typically developed Cantonese-speaking children during their conversations with caregivers and other adults. The corpus consists of a number of conversation recordings collected from children aged from 1 year to 3 years old. Each recording file contains between 1,500 to 3,000 uttered sentences. The size of the corpus is a total number of N=264,913 sentences with around 1.18 million Traditional Chinese characters. The sentences are tokenised and pre-processed by the word_tokenize and en_stops modules in Python's Natural Language Processing Toolkit (NLTK) library.

### AAC Vocabularies

Two popular AAC vocabularies used by the Hong Kong non-verbal population, namely those published by SAHK and Hong Chi Association (Hong Chi) are studied. The SAHK and Hong Chi AAC vocabularies respectively contain 661 and 1343 Cantonese terms are represented in picture-based communication symbols. In addition, the Universal Core vocabulary is also evaluated, which is a prioritised set of 36 highly used words (called the semantic primes) adopted by a wide range of AAC applications and speech-generating devices among the global non-speaking population.

### Rate-Distortion Models

For each of the AAC vocabularies described above, the distortion model is obtained by two algorithms. Algorithm 1 evaluates the rate-distortion function by calculating the distortion measure with one symbol being randomly introduced to the reproduction alphabet at a time. Algorithm 2 first ranks the symbols by their frequency of occurrence in the corpus (from the lowest to the highest and vice versa) and then evaluates the rate-distortion function in the same way as in Algorithm 1. Details of the algorithms are as follows:

```
Algorithm 1: Evaluation of the Rate-Distortion Function by Random
Symbols Introduction
Input : Source sequence dataset [symbol]   , reproduction alphabet, X, M = | \hat{X} |
Output : Distortion D and rate-distortion R(D)
Initialisation : Prepare the codebook Cₒ = {∅},
for i = 1, 2 ..., M do
  | Update Cᵢ₋₁ to an (n, i) codebook Cᵢ, by randomly
  | adding one non-repeating codeword
  | \hat{x} ∈ { \hat{x}, ...., \hat{x}(M)} where \hat{x} ∉ Cᵢ₋₁.
  | foreach x ∈ [symbol]   do
  | | foreach x ∈ x do
  | | | Encode x into an index K ∈ {0, 1, ...., M}
  | | | according to the AAC coding scheme and
  | | the codebook Cᵢ.
  | end
          \hat{x} = \hat{x} (K)or \hat{x} =  x′(κ(K))
    end
    Calculate distortion: Dᵢ = E[d(x, \hat{x})]
    Calculate rate-distortion R(Di) = I(X; \hat{X})
end
return D = {D₀,......, D_{M}}
return R(D) = {R(D₀),......, R(D_{M})}
Algorithm 2: Evaluation of the Rate-Distortion Function by Ranked Symbols
Introduction
Input : Source sequence dataset [symbol]   , reproduction alphabet, X, M = | \hat{X} |
Output : Distortion D and rate-distortion R(D)
Initialisation : Rank the codewords
{\hat{X}(1), ..... , \hat{X}(M)} by the occurences of
{x(1), ..... , x(M)} in the source sequence, Prepare the codebook Cₒ = {∅},
for i = 1, 2 ..., M do
  | Update Cᵢ₋₁ to an (n, i) codebook Cᵢ, by randomly
  | adding one non-repeating codeword
  | \hat{x} ∈ { \hat{x}, .... , \hat{x}(M)} where \hat{x} ∉ Cᵢ₋₁.
  | foreach x ∈ [symbol]    do
  | | foreach x ∈ x do
  | | | Encode x into an index K ∈ {0, 1, .... , M}
  | | | according to the AAC coding scheme and
  | | the codebook Cᵢ.
  | end
        \hat{x} = \hat{x} (K)or \hat{x} = \hat{x}′(κ(K))
    end
    Calculate distortion: Dᵢ = E[d(x, \hat{x})]
    Calculate rate-distortion R(Di) = I(X; \hat{X})
end
return D = {D₀,......, D_{M}}
return R(D) = {R(D | ),......, R(D_{M})}
```

### Reproduction Sequence Entropy and Symbol Efficiency

For each of the AAC vocabularies, the reproduction sequence entropy H(\hat{X}) resulting from the corresponding reproduction alphabet x are defined as:

$$H ( \hat{X} ) = - ( {\sum }_{i = 0}^{M} p ( x ( i ) ) {log}_{2} p ( x ( i ) ) ) \qquad ( 21 )$$

The symbol efficiency \hat{X} is also defined as a ratio between the reproduction sequence entropy and the size of the reproduction alphabet as

$$ϵ = \frac{H ( \hat{X} )}{\vert \hat{X} \vert} , \qquad ( 22 )$$

which is a quantity (having the unit of bits per symbol) that measures the average information content conveyed by each AAC symbol. Besides, the distortion D and rate R are defined according to Equation (18) and Equation (20), respectively.

Described as follows are the results obtained based on the above mathematical model in the AAC system of the AAC device.

### Results

Generally, the CHILDES Cantonese Lee Wong Leung corpus is used as the source sequences to study the rate-distortion measure of the two major Cantonese AAC vocabulary in Hong Kong and also the Universal Core vocabulary. The distortion and rate against the size of each of these AAC vocabularies are studied according to Equations (13) and (15), respectively. Finally, the rate-distortion functions of these three symbol sets are obtained. The corpus is used to evaluate the distortion and mutual information between the source sequences and the reproduction sequences of the three AAC vocabularies. The entire corpus of 264,913 sentences is used to evaluate the rate-distortion functions of each of the three AAC vocabularies.

### Analysis of Entropy and Symbol Efficiency

The resulting reproduction sequence entropy and the symbol efficiency of the three symbol sets are listed in Table 1. The SAHK AAC vocabulary yields the lowest reproduction sequence entropy (7.524 bits) and is followed by the Universal Core vocabulary (7.556 bits). The reproduction sequence entropy of the Hong Chi AAC vocabulary is the highest (7.959 bits) among the three. The Universal Core vocabulary achieves the highest symbol efficiency at 0.210 bits per symbol, which is significantly higher than that of SAHK (0.011 bits per symbol) and Hong Chi (0.006 bits per symbol) AAC vocabularies.

TABLE 1

| Symbol set | Size \|\hat{X}\| | Entropy H(\hat{X}) | Symbol efficiency ϵ |
|---|---|---|---|
| SAHK | 661 | 7.524 bits | 0.011 bits per symbol |
| Hong Chi | 1,343 | 7.959 bits | 0.006 bits per symbol |
| Universal Core | 36 | 7.556 bits | 0.210 bits per symbol |

### Analysis of Distortion by Vocabulary Size

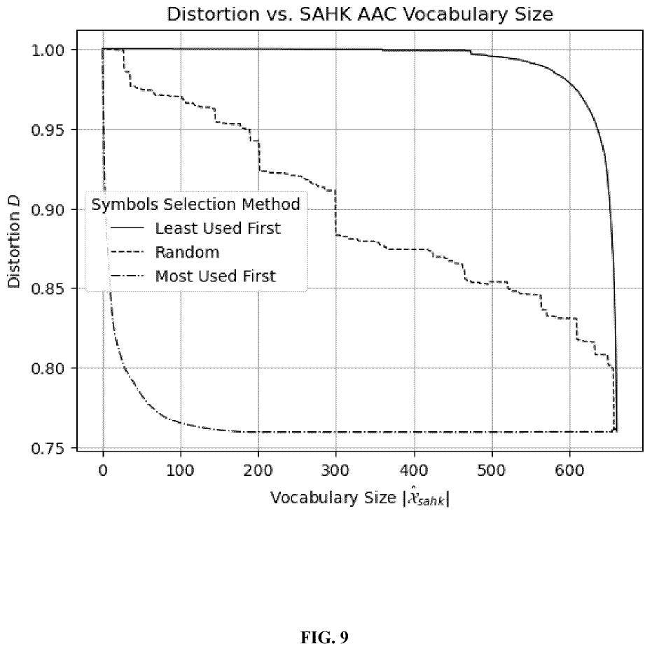

The plots of distortion (D) against the vocabulary size |\hat{X}| for the three symbol sets are presented in FIGS. 9 to 11, respectively. Similar trends are obtained in all three sets. When the symbols are randomly selected for the vocabulary, the distortion decreases steadily except for a few rapid descents. Otherwise, the decreases in distortion remain relatively stable as the vocabulary size increases. It suggests that when symbols are introduced randomly, individual symbol inclusion does not significantly impact the distortion. When the less frequently used symbols are included first, the distortion remains close to 1 at first and has a gradual decrease after the 443rd symbol (for SAHK) and the 1000th symbol (for Hong Chi). A sharp decrease in distortion is noticed when the last batch of symbols is introduced in both SAHK and Hong Chi symbol sets. When the most frequently used symbols are included first, the distortion decreases rapidly initially and then levels off in both SAHK and Hong Chi AAC symbol sets. However, a small increase of distortion from 0.50 to 0.58 is observed when the 864th most frequently used card was introduced to the vocabulary. This is because the Hong Chi AAC vocabulary simultaneously contains the cards for “I”, “want”, while the 864th frequently used card has the composite meaning “I want”. Therefore, when the latter is introduced into the vocabulary, the value of n in Equation (7) decreases by one since “I want” became one token instead of two (“I” and “want”). As a result, this leads to the increase in d(x,\hat{X}) and therefore the distortion D. The anomaly is not observed when the AAC symbols are introduced randomly and in an opposite ranking. Compared to SAHK and Hong Chi, the Universal Core vocabulary shows a steadier decreasing pattern when the ranked symbols are introduced.

### Analysis of Information Rate by Vocabulary Size

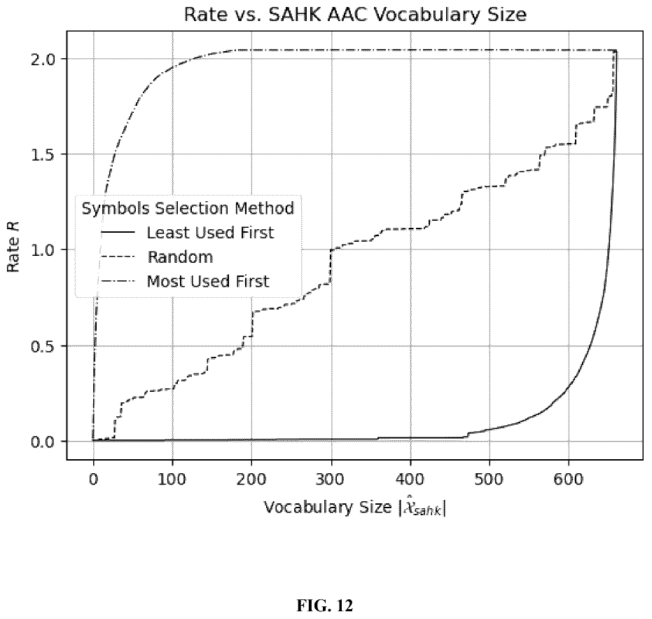

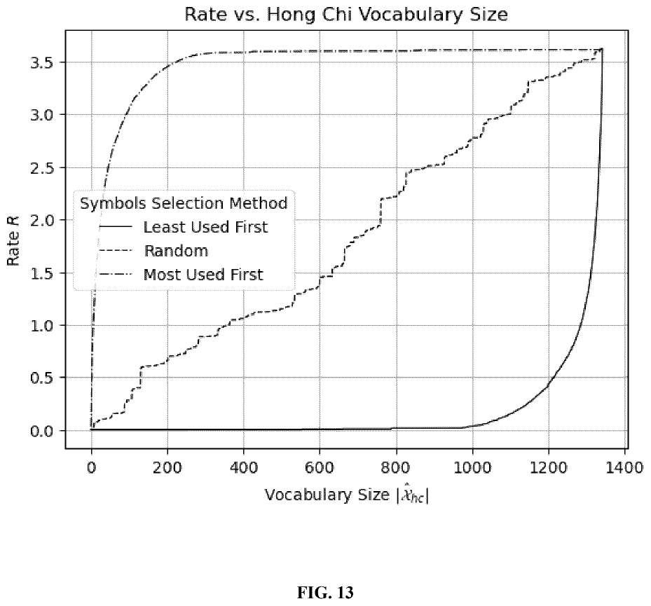

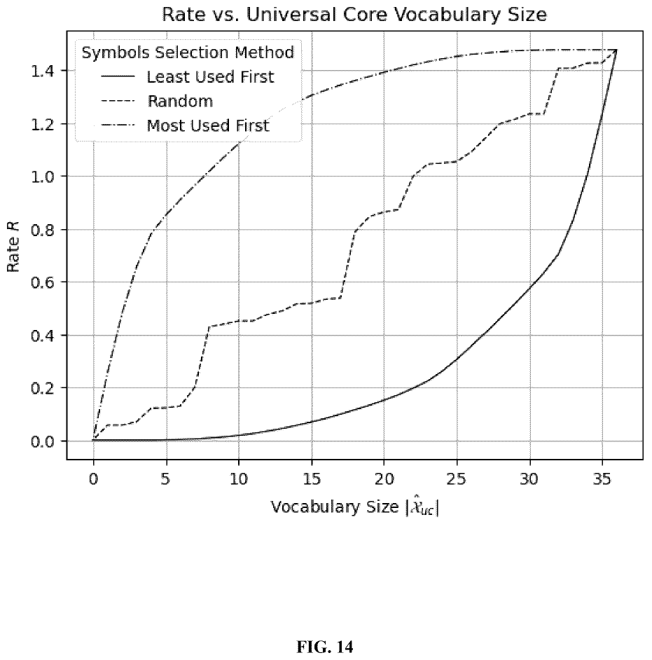

The plots of rate (R) against vocabulary size |\hat{X}| for SAHK, Hong Chi, and Universal Core AAC symbol sets are presented in FIGS. 12 to 14, respectively. Similar trends are obtained in the evaluation of all of the three AAC symbol sets. When the symbols are randomly introduced to the vocabulary, the rate increases steadily except for a few rapid rises. Otherwise, the increases in rate remain stable as the vocabulary sizes increase. When the less frequently used symbols are included first, the rate remains close to 0 at first and has a gradual decrease later on. Then a sharp increase in rate is observed when the last batch of symbols is introduced. Lastly, when the most frequently used symbols are included first, the rate rises rapidly and continues to increase and then levels off with the 181st (for SAHK) and 400th (for Hong Chi) symbol. The Universal Core vocabulary shows a more steady decreasing pattern compared to SAHK and Hong Chi AAC vocabularies when the ranked symbols are introduced.

### Rate-Distortion Function of AAC Vocabularies

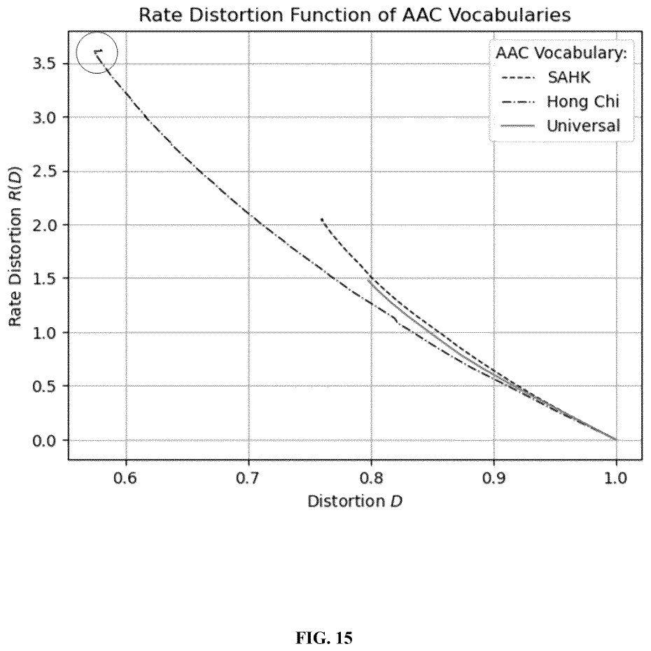

The rate-distortion functions of the SAHK, Hong Chi, and Universal Core AAC vocabularies are presented in FIG. 15. It is shown that the Hong Chi vocabulary that contains the largest number of symbols (|\hat{X}_{hc}|=1,434) achieves the lowest distortion D_{hc}=0.580 and the corresponding highest rate, R_{hc}(D)=3.623 bits. The minimum distortion achieved by SAHK (|\hat{X}ₛₐₙₖ|=661) and the Universal Core (|\hat{X}_{uc}|=36) vocabularies are Dₛₐₕₖ=0.762 and D_{uc}=0.798, respectively. These distortions correspond to the maximum rates of Rₛₐₕₖ(D)=2.037 bits for the SAHK vocabulary and R_{uc}(D)=1.478 bits for the Universal Core vocabulary, respectively.

It is observed that under the distortion range common among the three vocabularies that lie between 0.798 and 1.000, the rate-distortion measures R(D) of the SAHK AAC vocabulary are constantly higher than that of the Universal Core and the Hong Chi AAC vocabularies. Specifically, at the common distortion of 0.798, the three vocabularies achieve rates of 1.608 bits, 1.478 bits, and 1.416 bits, respectively. The present results generally align with Lemma 1. As shown in FIG. 15, all of the three rate-distortion curves are non-increasing in D and are convex. Besides, Dₘₐₓ=1 for all of the three vocabularies and R(D)=0 for all D≥Dₘₐₓ. However, an anomaly (highlighted in a circle and top-left) is observed in the rate-distortion curve of Hong Chi AAC vocabulary. This is due to the existence of three AAC symbols in the vocabulary having composite and overlapping meanings, namely “I”, “want”, and “I want”. The alternative selection of two symbols (“I”, “want”) or a single symbol (“I want”) makes the same information rate of 3.614 bits to be achievable under two distinct distortion values (0.5802 and 0.5804, respectively).

### Distortion-Rate Function of AAC Vocabulary with Semantic Structure

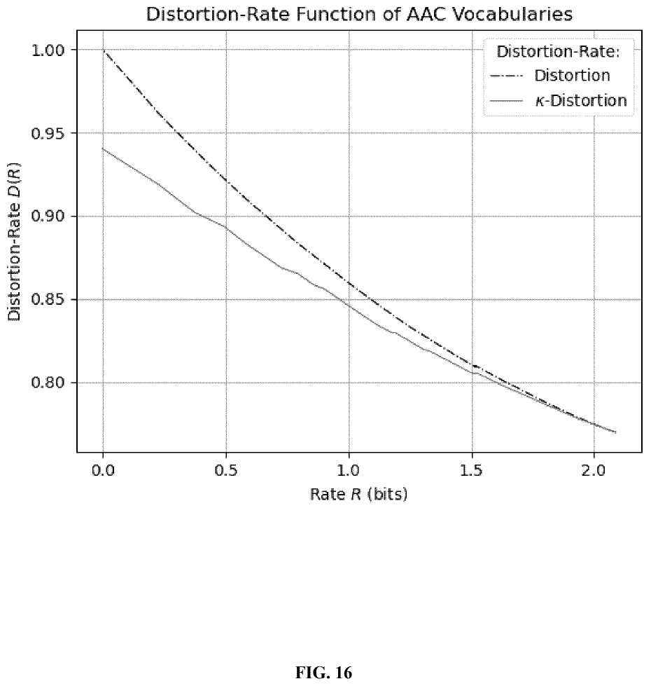

The SAHK vocabulary is the only one amongst the three AAC vocabularies (SAHK, Hong Chi, and Universal Core) that contains a semantic structure. Specifically, the 661 symbols are grouped into 32 classes. Here, the two distortion-rate curves are, one obtained from single letter distortion measure, and one obtained from K-single letter distortion measure to show the change in the probability of error (in terms of distortion-rate, D(R)) introduced by class symbol substitutions (as described in the AAC coding scheme with semantic structure). The distortion-rate curves of its single-letter distortion measure and K-single letter distortion measure are given in FIG. 16. It is shown that the K-single letter distortion measure obtained by substituting unavailable symbols with their corresponding class symbols constantly yields a lower D(R) (i.e., a lower probability of error) under the same rate R when compared to the original coding scheme without class symbols substitution. The difference is the largest at R=0 bit, and gradually diminishes to R=2.09 bits.

### Discussion

### Impact of Vocabulary Selection on Distortion

Having observed the distortion patterns obtained from the empirical studies can provide insights into the relationship between the way to select symbols into the vocabulary and the resulting distortion. The generally steadily decreasing pattern observed in distortion when the symbols are introduced into the vocabulary randomly suggests that individual symbol inclusion does not significantly impact the distortion, except for a few symbols that cause sharp decreases in distortion values. The pattern observed when the least frequently used symbols are included first suggests that the initial symbols do not contribute significantly to distortion reduction. However, the gradual and then sharp decreases in distortion later on suggest that as more frequently used symbols are included, the reproduction sequence becomes more accurate and aligned with the source sequence. Lastly, the sharp initial decreases in distortion observed when the most frequently used symbols are included first suggest that these few initial symbols contribute significantly to distortion reduction. Even though the decreasing trend slows down because the additional symbols have less effect on distortion reduction. By including the most frequent symbols in the vocabulary first, the symbols are prioritised by their ability to preserve fidelity. Therefore, a smaller set of vocabulary can achieve a low distortion when compared with the other two symbol selection methods.

Overall, the results obtained emphasise the positive influence of including more frequent symbols first in reducing distortion. Initially, when only a few symbols are selected, there is a significant impact on distortion reduction, and as more symbols are included, the reproduction consistently becomes more accurate, leading to enhanced fidelity. Although the rate of improvement may gradually decrease as additional symbols are included, the inclusion of more frequent symbols ensures that crucial information is preserved early on, contributing to the overall reduction in distortion. These findings highlight the effectiveness of prioritising the inclusion of more frequent symbols for achieving high-fidelity reproduction and manifest the importance of thoughtful symbol selection and ordering to optimise distortion reduction.

### Impact of Vocabulary Selection on Information Rate

The variation patterns of information rate by vocabulary size in all of the three AAC vocabularies are alike. Similar to the previous discussion on distortion, the observed distortion patterns can also reveal the relationship between the AAC vocabulary selection methods and the resulting rate. The steady increase in rate when the symbols are introduced randomly suggests that as more symbols are introduced to the vocabulary, the mutual information between the source and reproduction sequences increases. In particular, a few rapid rises in rate occur when more frequently used symbols are introduced, leading to a sudden increase in rate. When the least frequently used symbols are introduced first, the initial low (close to 0) rate suggests that the less frequently used symbols have a low contribution to mutual information between the source and reproduction sequences. The gradual increase in information rate at a later stage indicates that as more of these symbols are introduced, the mutual information between the source and reproduction sequences increases. Lastly, the sharp increase in rate when the last batch of symbols is introduced suggests that these symbols have a high contribution to the mutual information between the source and reproduction sequences.

Compared to the two methods discussed above, high information rates can be observed at an early symbol selection stage when the most frequently used symbols are introduced first. This suggests that a few of the most frequently used symbols alone can already contribute to a high quantity of mutual information between the source and reproduction sequences. For SAHK and Hong Chi AAC symbol sets, the information rate continues to increase later on, although less rapidly. Lastly, when more symbols are introduced, the information rate levels off. This suggests that additional symbols introduced after around the first 25% of the most frequently used symbols do not noticeably increase the mutual information between the source and reproduction sequences. Nevertheless, for the Universal Core vocabulary, the information rate increases steadily under all of the three vocabulary selection methods. This suggests that the majority of the 36 symbols are significant as their selection into the vocabulary yields a significant increase in information rate. This is also reflected in the high symbol efficiency value of (ϵ=0.21 bits per symbol) the Universal Core AAC vocabulary.

### On Rate-Distortion Function of AAC Vocabularies

The rate-distortion function of SAHK, Hong Chi, and Universal Core AAC vocabularies have been resolved using the CHILDES Cantonese Lee Wong Leung corpus. The empirical studies demonstrate that rate-distortion theory applies to the representation of children's daily conversation in AAC symbols. Specifically, all of the curves for the rate-distortion function of the three AAC vocabularies are non-increasing in D and are convex. The results show that the Hong Chi AAC vocabulary, which contains the largest number of symbols among the three sets, has achieved the lowest distortion and the highest rate (FIG. 15). This suggests that the Hong Chi AAC vocabulary can provide a more fine-grained and, therefore, accurate representation of the source compared to the other two vocabularies. Nevertheless, it is noted that the Universal Core vocabulary, which contains only 36 symbols, can achieve a comparable reproduction sequence entropy to that of the SAHK AAC vocabulary (661 symbols) and the Hong Chi vocabulary (1,343 symbols). This suggests that each of the symbols in the Universal Core vocabulary, on average, conveys more information than those of SAHK and Hong Chi.

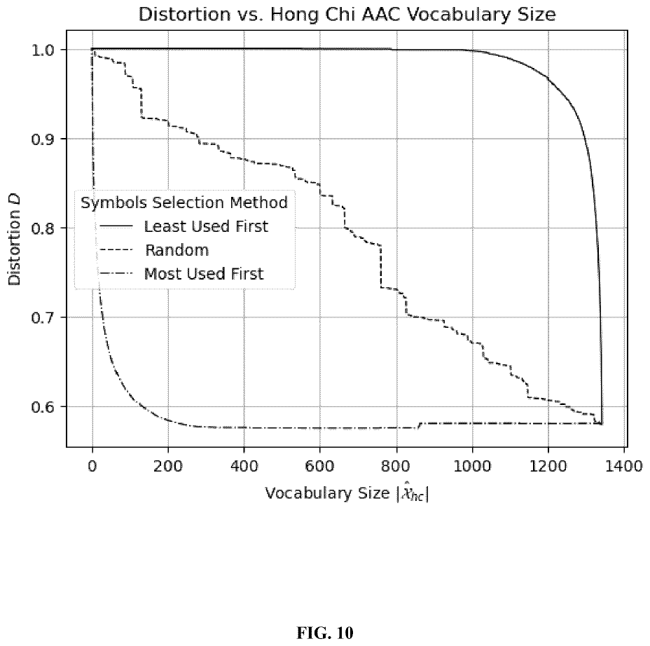

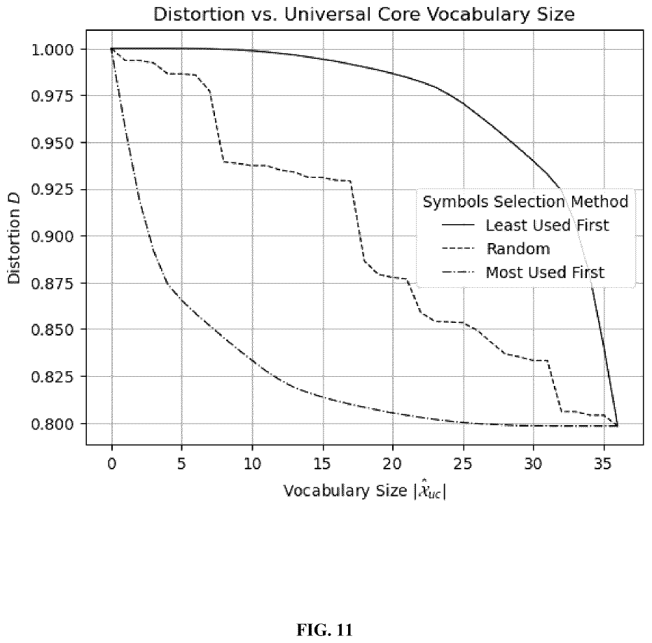

FIG. 15 also shows that the rate-distortion measures R(D) of the SAHK AAC vocabulary are consistently higher than those of the Hong Chi and Universal Core vocabularies. As the rate-distortion function manifests the trade-off between the rate (information content) and the distortion (reproduction error) in data representation, the results suggest that the SAHK symbols set achieves the highest rates at the same distortion level. It is worth noting that an atypical use of communication symbols, such as having multiple AAC symbols with overlapping meanings simultaneously, will cause anomalies in the rate-distortion function. For example, the anomaly observed in the Hong Chi AAC vocabulary (FIG. 10) is caused by the co-existence of AAC symbols representing “I”, “want”, and “I want”. This suggests that the rate-distortion function is sensitive to symbol structure, making it a very useful mathematical tool to examine the design and optimisation of the AAC symbol sets.

### On the Reduction of Communication Error by Leveraging on AAC Vocabulary Semantic Structure

It is shown in FIG. 16 that for a given rate, the inclusion of the AAC vocabulary semantic structure into the coding scheme (that yields the K-single letter distortion measure) achieves lower rate-distortion (i.e., error probability) than the one without the structure (that yields the single letter distortion measure). This suggests that by leveraging on the semantic structure of an AAC vocabulary and allowing the substitution of a collection of symbols (e.g., n symbols designating various fruits) by the same class symbol (e.g., a single symbol designating “fruits”), a reduced communication error probability can be achieved with a smaller number of symbols (the number of required symbols is reduced by n−1). The above result has several implications, firstly, it shows that the AAC coding scheme with semantic structure is more efficient in terms of a lower probability of error at the same rate compared to the coding scheme without semantic structure. It also implies that class symbol substitution is a plausible source coding technique because it leverages the a priori semantic structure to encode a class of symbols into a single class symbol. In order words, such a scheme is an optimised encoding strategy that takes advantage of the internal structure of the symbols.

However, obtaining a set of symbols that explicitly specifies a semantic structure can be challenging for several reasons. For example, the meaning associated with AAC symbols often depends on the context, cultural background, and individual user's interpretation. Therefore, it is difficult to establish a universal semantic structure for the symbols. Besides, communication symbols often represent complex concepts and ideas. It is difficult to capture the underlying semantic structure of a range of concepts into a small set of class symbols. Moreover, symbols may have multiple meanings (e.g., apple as a kind of fruit or a brand), making it challenging to specify a single semantic structure for symbols explicitly.

### On Optimal Trade-off between Distortion and Rate in AAC Vocabulary Selection

Rate distortion theory is concerned with finding the optimal trade-off between the rate at which information is transmitted and the distortion introduced in the encoding process. In the current context, the rate refers to the mutual information shared between a non-verbal user's intended messages and the AAC device's output of symbol sequences; while the distortion refers to the loss (in terms of the expected value of the hamming distance between x and \hat{ }x) incurs in an alternative representation of the user's message by AAC symbols. Based on the empirical evidence obtained in the present invention, the following suggestions for AAC vocabulary selection are considered:
When selecting symbols into an AAC vocabulary, it is important to consider their frequency of occurrence. As shown in the empirical results, symbols that are less frequently used have a lower contribution to the information rate.
The symbols should be introduced to the vocabulary gradually, especially when those with a high frequency of usage are selected. This enables the detection of the level-off position, where the further addition of symbols has little effect on the increase in rate or the decrease in distortion.
The rate-distortion curves (FIGS. 15 and 16) provide important insight into the AAC vocabulary's representativeness of a non-verbal user's intended messages. Besides enabling one to evaluate the rate of the AAC device and the distortion in symbol output, it also enable us to compare the performance (in terms of information rate) of different AAC vocabularies at the same distortion level. Therefore, the rate-distortion function can help optimise the vocabulary selection process to achieve the desirable trade-off between rate and distortion in AAC.
A priori semantic structure of an AAC vocabulary can be leveraged to improve rate-distortion trade-off by substituting a class of symbols using a single class symbol. In this way, the level of distortion is reduced while the rate required to transmit a message remains unchanged. In other words, distortion is minimised under a given information rate.

### Conclusion

The proposed mathematical model for AAC herein describes the rate and distortion between a non-verbal user's intended messages and an AAC device's output sequences. The case when the source contains a priori semantic structure, which is often the case in natural languages. The objective function for AAC vocabulary selection, which ensures the information rate can be achieved at a given distortion. A series of linguistic experiments on three AAC vocabularies, including two popular Cantonese AAC vocabularies and the Universal Core vocabulary have been conducted. The present invention is scientifically important because the rate-distortion function of AAC aligns with the theoretical predictions. This provides empirical evidence for the validity and applicability of the rate-distortion theory in real-world scenarios. Such a finding also enables the inventors to conduct quantitative assessments of AAC vocabulary performance by comparing the rate-distortion function among different vocabularies. The rate-distortion measure also provides a benchmark metric for performance analysis and aids in identifying strategies to improve symbol efficiency in vocabulary selection.

The present invention explained above is not limited to the aforementioned embodiment and drawings, and it will be obvious to those having an ordinary skill in the art of the present invention that various replacements, deformations, and changes may be made without departing from the scope of the invention.

1. A method for optimizing symbols selection in a sentence writing in an Augmentative and Alternative Communication (AAC) device comprising:
receiving at least one user input;
encoding the user input as a sequence of indexes;
augmenting and alternating the sequence of indexes into a plurality of communication symbols;
generating optimal communication symbols for an optimized symbols selection;
selecting the optimal communication symbols based on relevance to user input; and,
displaying the optimized symbols for the sentence writing on a display interface of the AAC device.

2. The method according to claim 1, wherein the method further comprises:
accessing a database that stores a plurality of data; and,
capturing user interactions and evaluation data through a feedback mechanism to the database for adaptive learning.

3. The method according to claim 1, wherein the step of encoding the user input as the sequence of indexes further comprises:
identifying a plurality of concepts based on the at least one user input, wherein each concept is represented by an index.

4. The method according to claim 1, wherein the step of augmenting and alternating the sequence of indexes into the plurality of communication symbols further comprises:
applying a first algebraic model to assign a communication symbol to each identified concept or a null symbol for concepts that lack a direct symbolic representation.

5. The method according to claim 1, wherein the step of augmenting the sequence of indexes in the plurality of communication symbols further comprises maintaining a signal-to-noise ratio in the sequence of indexes via a channel capacity (C).

6. The method according to claim 4, wherein the method further comprises:
applying a second algebraic model to generate the sequence of indexes with semantic structure.

7. The method according to claim 6, wherein the method further comprises:
defining superordinate relations amongst the communication symbols via an injective mapping; and,
assigning a single-class symbol to each concept to obtain the sequence of indexes.

8. The method according to claim 4, wherein the method further comprises:
establishing a distortion metric by scoring each communication symbol and establishing a distortion threshold level;
calculating mutual information between the user input and alternated communication symbols;
determining a minimum information rate based on the distortion threshold level;
selecting the optimal communication symbols in accordance with the distortion threshold level, wherein symbols meeting or exceeding the threshold level are prioritized for display in the AAC device; and,
measuring a single-letter distortion (d) as:
$$d ( {x}_{k} , {x}_{k} ) = \{ \begin{matrix}0 if f ( {x}_{k} ) \neq 0 \\ 1 if f ( {x}_{k} ) = 0\end{matrix}$$
where x is a source sequence, \hat{x} is a reproduction sequence, k is an index.

9. The method according to claim 6, wherein the method further comprises:
establishing a distortion metric by scoring each communication symbol and establishing a distortion threshold level;
calculating mutual information between the user input and alternated communication symbols;
determining a minimum information rate based on the distortion threshold level;
selecting the optimal communication symbols in accordance with the distortion threshold level, wherein symbols meeting or exceeding the threshold level are prioritized for display in the AAC device; and,
measuring a single-letter distortion with the semantic structure (d″k″) as:
$${d}_{k} ( {x}_{k} , {\hat{x}}_{k} ) \leq d ( {x}_{k} , {\hat{x}}_{k} )$$
where xₖ and \hat{x}ₖ are, respectively, the k-th symbol in the source and the reproduction sequence.

10. The method according to claim 8, wherein the method further comprises:
measuring a K-single-letter distortion between xₖ and \hat{X}ₖ, as:
$$d ( {x}_{k} , {\hat{x}}_{k} ) = \{ \begin{matrix}0 & if f ( {x}_{k} ) \neq 0 \\ {d}_{k} & if f ( {x}_{k} ) = 0 and κ ( k ) ∈ {I}^{′} \\ 1 & otherwise\end{matrix} ,$$
$$where ,$$
$${d}_{k} = \frac{( {Σ}_{κ ( j ) = κ ( k )} {n}_{j} ) - {n}_{k}}{{Σ}_{κ ( j ) = κ ( k )} {n}_{j}}$$
where, the symbol \hat{x} is replaced by its class symbol \hat{x}, denoting the class for the symbol; and,
representing a class for each symbol quantitatively as:
$$1 - {d}_{k} = \frac{{n}_{k}}{{Σ}_{κ ( j ) = κ ( k )} {n}_{j}}$$

11. The method according to any of claim 8, wherein the step of measuring the single letter distortion further comprises:
minimizing distortion between the user input and the reproduction sequence.

12. The method according to claim 11, wherein the step of minimizing distortion between the user input and the reproduction sequence further comprising:
determining a channel (Q*) as:
$$Q *= {arg min}_{Q : R ( D ) \leq C} R ( D )$$
$$where ,$$
$$D = {\sum }_{x , \hat{x}} {p}_{X , \hat{X}}^{( x , \hat{x} ) d ( x , \hat{x} )}$$
$$and ,$$
$${\sum }_{x , \hat{x}} p ( x ) p ( \hat{x} \vert x ) d ( x , \hat{x} ) \leq D$$
where D is the average distortion measure d(x, \hat{X}) weighted by the joint probability distribution pₓₓ(x, \hat{x}), and, p(x) is known data obtained from the database.

13. The method according to claim 8, wherein the method further comprises:
achieving minimum information rate, RI (D) as:
$${R}_{I} ( D ) = {min}_{p ( x \vert \hat{x} ) : {Σ}_{x , \hat{x}} p ( x ) p ( \hat{x} \vert x ) d ( x , \hat{x} ) \leq D} I ( X ; \hat{X} )$$
where, X is the user input, \hat{X} is an output, p(x) is an i.i.d distribution, and d(x, \hat{X}) is a bounded distortion function that equals to an associated rate-distortion function.

14. A system for optimizing symbols selection for sentence writing in an Augmentative and Alternative Communication (AAC) device comprising:
a database;
a processor in data communication with the database having instructions thereon that, when executed by the processor, causes the processor to:
receive at least one user input;
encode the user input as a sequence of indexes;
augment and alternate the sequence of indexes into a plurality of communication symbols;
generate optimal communication symbols for an optimized symbols selection;
select the optimal communication symbols based on relevance to user input; and,
display the optimized symbols for the sentence writing on a display interface of the AAC device.

15. The system according to claim 14 wherein the database includes but is not limited to a cloud database.

16. The system according to claim 14, wherein the database stores a plurality of data including but not limited to user interactions data, performance data, at least one vocabulary library and user model data.

17. The system according to claim 14, wherein the user model data includes user preferences and user performance metrics.

18. The system according to claim 14, wherein the vocabulary library is customizable, wherein user-specific symbols are added in the vocabulary library.

19. The system according to claim 14, wherein the system is configurable for implementation across various AAC devices.
